(19) United States
(12) Patent Application Publication
(10) Pub. No.: US 2015/0212898 A1
(43) Pub. Date: Jul. 30, 2015

(54) DATA MIGRATION METHOD AND SYSTEMS

(71) Applicant: ATTIX5 UK LIMITED, Stellenbosch (ZA)

(72) Inventors: Theodor KLEYNHANS, Somerset West (ZA); Daniel Petrus MARAIS, Stellenbosch (ZA)

(21) Appl. No.: 14/325,241

(22) Filed: Jul. 7, 2014

(30) Foreign Application Priority Data
Jan. 30, 2014 (ZA) 2014/00738

(51) Int. Cl. G06F 11/14; H04L 29/08; G06F 17/30

(52) U.S. Cl. CPC G06F 11/1448; G06F 17/30079; G06F 17/30203; H04L 67/06; G06F 2201/80

(57) ABSTRACT

The invention relates to a method and system for migrating data stored in a second computing system to a first computing system, particularly wherein the first computing system is a local file system and the second computing system is a backup file system storing files to be transferred to the local file system. The method comprises pre-allocating a primary file matching a corresponding secondary file the second computing system. In response to receiving a read request for a data block not yet stored in the primary file, method comprises retrieving the requested data block from the secondary file and storing same locally in the primary file such that it is usable in the local system. The primary file is automatically populated with data blocks from the secondary file until it is complete in respect of data blocks stored. The system substantially carries out the method of the invention.

### FIELD OF INVENTION

This invention relates to a method and systems for data migration, particularly to a method and systems for migrating data from backup computing or file systems to the local computing or file systems in data restoration procedures.

### BACKGROUND OF THE INVENTION

Conventionally, data from local file systems is backed-up to remote backup file systems such that in the event of data loss in the local computing systems, data from the corresponding backup file system is restored to the local file system as part of a disaster recovery process. The restoration entails the complete transfer of all the data or files, or at least a single file in its entirety, to the local file system in order to be usable by the same.

Due to the size of some data items or files (e.g., multi-terabyte single files) and hardware constraints (e.g. network speed and the speed of hard disks in the local file systems), restoring data from backup file systems to local file systems is slow with full data recovery taking many hours to complete resulting in much downtime at the local file system. For example, it will take almost three hours to copy a single 1 terabyte file writing at the full speed of a standard hard disk (about 100 MB/s). It follows that the amount of downtime experienced in restoring data to a local file system from a backup file system is impractical and undesirable, particularly in a disaster recovery scenario where it is critical to recover data from the backup file system as a matter of urgency.

In some conventional systems, the downtime in restoring data to the local file system is ameliorated by presenting backed-up data on a virtual local file system, thereby allowing it to be immediately usable. However, these systems have a drawback in that the virtual file system still needs to be dismounted or removed in the future, requiring the migration of used files to permanent storage which will result in downtime of the system. It follows that this approach merely delays the downtime experienced with the restoration of data on a local file system until the migration of the same to permanent storage.

It is an object of the invention to address the drawbacks mentioned above or at least provide an alternate means to transfer or migrate data between servers or file systems, for example, to restore a local file system from a backup file system.

### SUMMARY OF THE INVENTION

According to a first aspect of the invention, there is provided a method of migrating data stored in a second computing system to a first computing system, wherein the method comprises:
pre-allocating, in a data storage device of the first computing system, at least one primary file substantially matching at least an identifier and size of a corresponding secondary file stored in a suitable data storage device of the second computing system;
receiving and/or intercepting a read request or a write request for a data block stored in the at least one primary file;
determining, in response to receiving and/or intercepting a read request, whether or not the requested data block is stored in the primary file;
responsive to, or in response to, determining that the requested data block is not stored in the primary file, retrieving a data block corresponding substantially to the requested data block from the secondary file;
storing the retrieved requested data block from the secondary file accordingly in the at least one primary file such that the retrieved data block is presented in the first computing system; and
retrieving other data blocks from the secondary file and storing the retrieved other data blocks correspondingly in the at least one primary file, in the absence of receiving read or write requests, until the primary file is complete in respect of data blocks stored.

Instead, or in addition, to intercepting the method may comprise receiving the requests for data blocks in the at least one primary file. It follows that the method may comprise a step of monitoring requests to and from the at least one primary file so as to intercept read and/or write requests.

The method may comprise interrogating the intercepted read or write request to determine block information indicative of the data block associated with said request, wherein the block information comprises:
identifier information to identify the at least one primary file to which the request for the data block relates; and
location information to determine a location of the requested data block within the primary file, wherein the location information comprises a data offset and length of the requested data block.

The primary file may match a mapping of data blocks stored as in the secondary file in respect of at least the location of the data blocks in the secondary file. In this way, retrieving a corresponding data block in the secondary file may also comprise using the location information associated with the requested data block to locate and subsequently retrieve a corresponding data block located at a same position, as described by the location information, in the secondary file as will be described below.

The method may comprise storing the retrieved data block in the identical location or offset in the at least one primary file as determined by the block information associated with the requested data block.

It will be noted that the method may comprise interrogating a received request to determine whether or not a received request is a read or write request.

The data stored in the second computing system may comprise data backed-up for storage thereto, such that the data block retrieved from the second computing system is a backup data block.

The method may comprise receiving an identifier and size of a corresponding at least one secondary file stored in the second computing system so as to pre-allocate the same in the first system.

The identifier may be a unique identifier associated with the secondary file, for example, a name thereof which corresponds to the name of a file lost or corrupted in the first computing system.

The request may be received from a data requestor in the first computer system.

The at least one primary file may be an individual file, and wherein the method may comprise pre-allocating the individual at least one primary file to an existing file system stored in the data storage device of the first computing system. In this way, the method need not migrate an entire volume from the second computing system and individual files may be migrated.

In response to storing retrieved requested data block in the at least one primary file, the method may comprise forwarding the received read request to the at least one primary file for processing or transmitting the retrieved requested data block to a data requestor of the requested data block.

It will be appreciated that the method may comprise retrieving the requested data block from the at least one primary file, for use by the data requestor, in response to determining that the requested data block is stored in the at least one primary file. Alternatively, the method may comprise transmitting the received request to the at least one primary file for conventional processing, in response to determining that the requested data block is stored in the at least one primary file.

The method may comprise pre-allocating data block locations in the at least one primary file corresponding to particular locations of data blocks stored in the at least one secondary file.

Pre-allocating the data blocks may comprise essentially assigning data block locations in the at least one primary file corresponding to locations and hence sizes of the corresponding data blocks in the at least one secondary file

The method may comprise pre-allocating a plurality of primary files corresponding to a plurality of secondary filed stored in the second computing system. It follows that the method may be used for all primary and secondary files, or a least some of these files. The method may therefore comprise using the identifier information of the received block information to identify the at least one primary file associated with a received request. The method may comprise using the location information to locate the corresponding data block in the identified primary file or secondary file, as the case may be, so as to retrieve the same, in use.

The method may comprise maintaining a log of data block locations in the primary file which have data blocks stored therein. In this way, it can be determined which data block still need to be retrieved from the secondary file.

In response to receiving a write request to store a data block in a particular data block location, the method may comprise storing the data block in the particular data block location in the at least one primary file.

The method may comprise maintaining the abovementioned log for those data blocks in the at least one primary file which have data blocks associated with a received write request stored therein.

The method may comprise storing retrieved data blocks in the pre-allocated data blocks in the primary file by caching requests.

The method may comprise establishing a communication link between the first and second computing systems so as to retrieve data blocks from the second computing system, in use.

As mentioned, or alluded to above, the method may in a preferred example embodiment of the invention, comprise the steps of:
monitoring and intercepting requests to and from the at least one primary file in an existing file system;
determining whether or not all data block locations in the at least one primary file have data blocks stored therein; and
ceasing monitoring and intercepting requests to and from the at least one primary file in response to determining that all data block locations in the at least one primary file have data blocks stored therein.

Differently defined, the method may comprise the steps of monitoring the at least one primary file and/or the abovementioned log to determine if all the pre-allocated data blocks have data blocks retrieved and/or data blocks as per write requests stored therein; and ceasing monitoring requests associated with the at least one primary file once all the pre-allocated data blocks have data blocks stored therein, in other words, the primary file is complete.

The method may comprise the step of intercepting requests to an operating system of the first computing system by data requestors in the first computing system.

The first computing system may be a local file system comprising an existing file system stored in the data storage device of the first computing system; and the second computing system may be a back-up file storage system communicatively coupled to the local file system.

The second computing system may be a remote computing system.

The method may comprise a step of introducing a filter driver between an operating system and application layer of the first computing system so as to intercept the requests to the operating system of the first computing system, particularly requests to and from the at least one primary file in the first computing system.

According to a second aspect of the invention, there is provided a system for migrating data stored in a second computing system to a first computing system, the system comprising a migration module configured to:
pre-allocate, in a data storage device of the first computing system, at least one primary file substantially matching at least an identifier and size of a corresponding secondary file stored in a suitable data storage device of the second computing system;
receive a read request or a write request for a data block stored in the at least one primary file;
determine, in response to receiving a read request, whether or not the requested data block is stored in the primary file;
in response to determining that the requested data block is not stored in the primary file, retrieve a data block corresponding substantially to the requested data block from the secondary file;
store the retrieved requested data block from the secondary file accordingly in the at least one primary file such that the retrieved data block is presented in the first computing system; and
retrieve other data blocks from the secondary file and store the retrieved other data blocks correspondingly in the at least one primary file, in the absence of receiving read or write requests, until the primary file is complete in respect of data blocks stored.

The system may comprise an intercepting module communicatively coupled to the migration module and disposed between an operating system or operating system module and application layer of the first computing system, wherein the intercepting module may be configured to monitor requests to and from the at least one primary file in the first computing system, and wherein the requests comprise block information indicative of data blocks associated with said requests.

The block information may comprise:
identifier information to identify the at least one primary file to which the request for the data block relates; and
location information to determine a location of the requested data block within the primary file, wherein the location information comprises a data offset and length of the requested data block.

The intercepting module may be in the form of one, or more, of a filter driver, mini-filter driver, and reparse point to intercept and/or receive requests directed to the operating system of the first computing system by one or more application/s.

The intercepting module may be configured to transmit received requests to the migration module.

The at least one primary file may be an individual file in an existing file system stored in the storage device of the first computing system.

The migration module may be configured to pre-allocate a plurality of primary files corresponding to at least some of a plurality of secondary files stored in the second computing system. In this way, only certain files corresponding files from the second computing system may be migrated to the pre-allocated files in the primary file. It will be noted that the term “at least some” may be understood to include at least one but not all the files in the second computing system. Similarly, the migration module may be configured to pre-allocate at least some primary files within an existing file system of the first computing system. It follows that the methodology as described above may comprise the step of pre-allocating at least some primary files in the existing first file system; and migrating the corresponding files from the second computing system.

Each primary file may comprise a plurality of pre-allocated data block locations corresponding to data blocks of an associated secondary file. The intercepting module and/or the migration module may be configured to maintain or populate a log of those data block locations in the primary file which have corresponding retrieved data blocks stored therein.

In response to intercepting and/or receiving a write request, the migration module and/or the intercepting module may be configured to store or write a data block associated with the write request in the at least one primary file. Instead, or in addition, in response to retrieving, from the secondary file, and storing, in the primary file, the data block requested, the intercepting module may be configured to transmit the data block requested to the requesting application, transmit the retrieved data block to the operating system for transmission to the application, and/or instruct the operating system to retrieve the data block requested from the primary file in which the same is stored.

For example, the data block associated with the write request may be written to a particular pre-allocated data block location therein; and, in response to receipt of said write requests, the migration module or the intercepting module may be configured to store the data block in the at least one primary file. It will be appreciated that the write request may also comprise block information associated with the data block to be stored so as to locate the pre-allocated. The intercepting module may be configured to maintain the abovementioned log for those data blocks in the at least one primary file which have data blocks associated a received write request stored therein.

The migration module and/or the intercepting module may be configured to retrieve the requested data block from the at least one primary file in response to determining that the requested data block is stored in the at least one primary file.

The intercepting module may be controllable by way of the migration module.

The system may comprise a communication link communicatively coupled to the migration module as well as to both the first and second computing systems.

The intercepting module may be configured to determine whether all data block locations in a primary file have retrieved data stored therein or not, the intercepting module being configured to cease monitoring requests to and from the primary file in response to determining that all data block locations in the primary file have been retrieved data blocks stored therein. In this regard, the intercepting module may be configured to monitor the at least one primary file and/or the abovementioned log to determine if all the pre-allocated data block locations have data blocks retrieved and/or data blocks as per write requests stored therein, the intercepting module being further configured to cease monitoring requests associated with the at least one primary file once all the pre-allocated data block locations have data blocks stored therein, in other words, the primary file is complete.

The first computing system may be a local file system and the second computing system may be a back-up file storage system communicatively coupled to the local file system.

According to a third aspect of the invention, there is provided a non-transitory computer readable storage medium comprising a set of instructions, which when executed by a computing device causes the same to:
pre-allocate, in a data storage device of the first computing system, at least one primary file substantially matching at least an identifier and size of a corresponding secondary file stored in a suitable data storage device of the second computing system;
receive a read request or a write request for a data block stored in the at least one primary file;
determine, in response to receiving a read request, whether or not the requested data block is stored in the primary file;
in response to determining that the requested data block is not stored in the primary file, retrieve a data block corresponding substantially to the requested data block from the secondary file;
store the retrieved requested data block from the secondary file accordingly in the at least one primary file such that the retrieved data block is presented in the first computing system; and
retrieve other data blocks from the secondary file and store the retrieved other data blocks correspondingly in the at least one primary file, in the absence of receiving read or write requests, until the primary file is complete in respect of data blocks stored.

### BRIEF DESCRIPTION OF THE DRAWINGS

FIG. 1 shows a high level schematic view of a system for migrating data, in accordance with an example embodiment of the invention;

FIG. 2 shows a lower level schematic view of a system of FIG. 1;

FIG. 3 shows a flow diagram of a method of migrating data in accordance with an example embodiment of the invention; and

FIG. 4 shows a diagrammatic representation of a machine in the example form of a computer system in which a set of instructions for causing the machine to perform any one or more of the methodologies discussed herein, may be executed.

### DETAILED DESCRIPTION OF THE DRAWINGS

In the following description, for purposes of explanation, numerous specific details are set forth in order to provide a thorough understanding of an embodiment of the present disclosure. It will be evident, however, to one skilled in the art that the present disclosure may be practiced without these specific details.

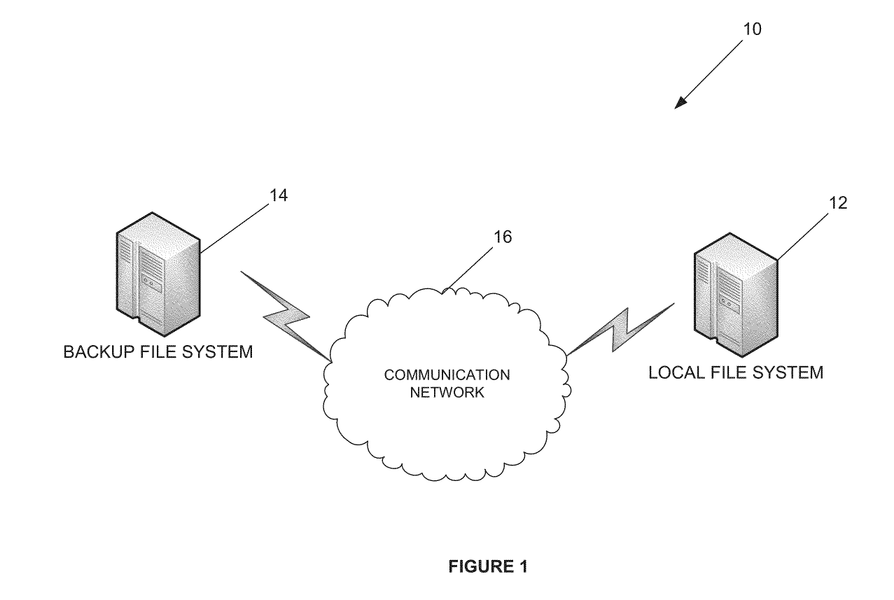

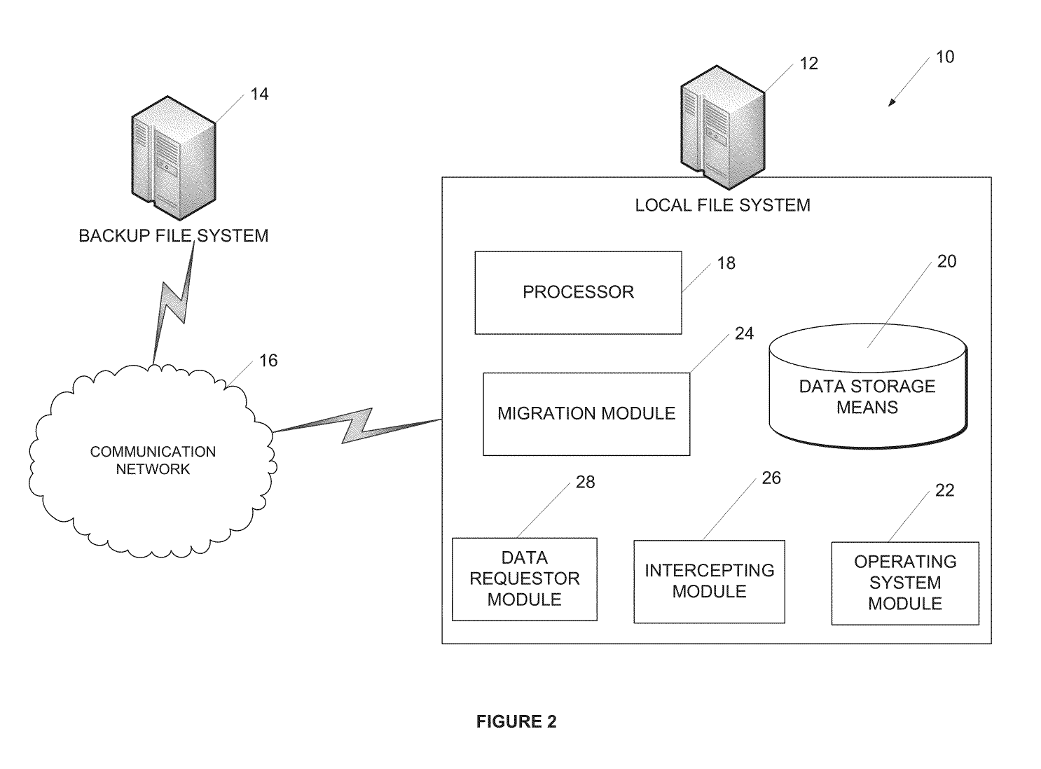

Referring to FIGS. 1 and 2 of the drawings, a system for migrating data in accordance with an example embodiment of the invention is generally indicated by reference numeral 10. The system 10 is typically a networked system comprising at least two computing systems, for example, a first or local computing system 12 having a local file system and a second or backup computing system 14 having a backup file system, communicatively coupled to each other via a communication network 16.

Though the system and methodology described herein may find application in various other data transfer and/or migration applications where data is transferred from one server to another, the system 10 described herein is described with reference to restoring data lost in the local computing system 12 with data previously backed-up thereby to the backup computing system 14. In this regard, as is the case in conventional backup file systems, the backup file system would have previously received (e.g., on a periodic, ad hoc, or otherwise determined fashion) primary or local data files from the local file system via the communication network 16. Local data files received for backup by the backup computing system 14 are typically stored in a suitable data storage means associated with the system 14 as identical secondary or backup data files of the local files, usually with the same file identifier or file name in the backup file system for ease of data restoration/recovery. In particular, the backup computing system 14 would have replicated all local files stored in the local file system as backup files in the backup file system such that data lost by the first computing system 12 may be recovered from the backup file system of the backup computing system 14 as will be described herein.

Further, it will be understood that the system and methodology described herein may further find particular application in live migrating or restoring an individual file to an existing local file system of the local computing system 12 without the need for migration of the whole volume, within which the individual file resides in the backup file system, to the local file system.

Though typically geographically spaced, the local computing system 14 and backup computing system 12 may be communicatively coupled to each other in a cloud-based computing fashion. It follows that the communications network 16 may therefore be a packet-switched network and may form part of the Internet, it may be a LAN, WAS, WLAN, or a satellite communications network. Instead, the communications network 16 may be a circuit switched network, public switched data network, or any other network for communicating media, or a combination of these mentioned networks.

Though only one local computing system 12 is illustrated, in some example embodiments a plurality of local computing systems 12 may be networked to a single backup computing system 14. Further, in some example embodiments, the systems 12 and 14 may each comprise a stand alone or multiple networked servers though only one of each is shown for ease of illustration. Furthermore in some example embodiments (not illustrated) multiple servers for each respective system 12 and 14 may be located at a single location. However, in other example embodiments, also not illustrated, multiple servers for each respective system 12 and 14 may be spread out geographically and networked, for example, across the communications network 16 to provide the functionality as described herein.

Moreover, in some example embodiments, not illustrated, the local computing system 12 may be in the form of a standalone personal computing device, such as a personal computer, laptop, tablet compute or the like which is capable of backing-up data to the backup server 14 and consequently capable of having data restored thereto in the event of data loss as described herein.

Turning now particularly to FIG. 2 of the drawings where a more detailed schematic view of the system 10 is shown. In FIG. 2, the local computing system 12 is illustrated to comprise a plurality of functional blocks and modules corresponding to the functions which the local computing system 12 is to perform. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device or system (e.g., system 12) but may be spread across a plurality of devices and systems (e.g., across the network 16) to provide the functionality described herein.

In any event, the local computing system 12 comprises a processor 18 (coupled with associated hardware, circuitry and components which are not illustrated) and local data storage medium, device or system 20. The system 12 also comprises an operating system module 22, a migration module 24, an intercepting module 26 and a data requestor module 28. It will be noted that some of the functionality of modules 24 and 26 may overlap or may be duplicated. However, they will be discussed separately for ease of explanation.

The data storage device 20 may be a machine-readable medium, main memory and/or a hard disk drive (e.g., RAM, ROM, EEPROM, CD-ROM, magnetic or optical disk storage, or the like) which stores data and carries a set of instructions to direct the operation of the processor 18, for example being in the form of one or more computer programs. It is to be understood that the processor 18 may be one or more microprocessors, controllers, digital signal processor (DSP) or any other suitable computing device, resource, hardware, software, or embedded logic. In one example embodiment, the processor 18 is programmed via suitable computer programs or software to provide the modules 22, 24, 26 and 28, or at least there functionality thereof.

It will be appreciated that the data storage device 20 is also configured to store a plurality of local files therein, or in other words a local file system or file structure comprising a plurality of local files. In a preferred example embodiment, the local file system of the system 12 is an existing file system having local files already stored therein. Though not illustrated, it will be appreciated that the backup system 14 has similar hardware and optionally software components as the system 14 including a similar data storage means which stores backup files in a backup file system as mentioned previously.

The operating system module 22 is typically configured to operate in a similar fashion to conventional operating systems in found in conventional computing, computer and/or data processing systems. The data requestor module 28 is generally an application or service operating in the local file system 12 in a conventional manner (e.g., Microsoft® SQL Server or Microsoft® Exchange Server) and is configured to request data from local files via suitable API calls. In one example embodiment, the module 28 is configured to request blocks of data from the local files stored in the storage device 20 in the local file system 12.

The blocks of data or so-called term “data blocks” in the specification will be understood to mean portions of data read from or written to local or backup files described herein, as the case may be. The term “data block” may refer to any size or format of data and may be defined by a range of bytes in a particular file as determined by a start offset and length of the data block in a particular file.

The intercepting module 26 is typically a filter driver (e.g., Microsoft Windows® filter driver), file system mini-filter driver, a reparse point, or the like which is configured to monitor, intercept and optionally modify requests to and from local files, typically between the module 28 and the operating system module 22. It follows that the module 26 may thus be located between the operating system and application layer of the local computing system 12.

In one example embodiment, when the data requestor module 28 requests a block of data from a local file via API calls, the module 26 in the form of a filter driver is configured to supply the data without reading it from the local storage device 20. Similarly, the intercepting module 26 will be able to see the content, size and offset of all blocks of data written to the local data storage device 20.

The request for a local data block associated with a local file by the data requestor module 28 comprises block information which comprises: identifier information such as a file name or unique identification code to identify the local file associated with data block requested; and location information such as the data offset and length or in other words a byte range, as mentioned above, to locate the requested local data block in the identified local file. In other example embodiments, the intercepting module 26 may be configured to determine the block information from the intercepted requests from the data requestor module 28.

Turning to the migration module 24, the module 24 is configured to control the intercepting module 26 to start and stop monitoring and intercepting requests to local files from the data requestor module 28. The module 24 is configured to facilitate restoring data from the backup file system 14 to the local file system 12. In particular, the migration module 24 is configured to pre-allocate, in data storage device 20, one or more local files substantially matching at least an associated identifier and size of corresponding related backup file stored in the backup file system 14. In other words, the module 24 is configured to create or generate, in the data storage device 20 an identical file shell of the backup file to be migrated from the backup file system 14 to the local file system 12, wherein the file shell is to be populated with data blocks from the corresponding backup file to be migrated. Once pre-allocated or created, the local file is available to be used by the data requestor module 28 which supports it. The module 24 is configured to pre-allocate a local file into an existing local file system 12, particularly, volume of data or local files in the local file system 12.

For ease of explanation, the same reference numeral used for the local computing system 12 will be used for further discussion of the “local file system” associated therewith. Further, similar considerations will apply to the “backup file system” associated with the backup computing system 14.

The intercepting module 26 is configured to transmit an intercepted request for a particular data block from the data requestor module 28 to the migration module 24. The module 24 is configured to use the block information associated with the received request (i.e., primary file, offset and length) to determine whether or not the requested data block is stored in the identified local file, or in other words whether the range of bytes requested can be satisfied from the local file (i.e., it has been written previously), or whether it needs to be retrieved from the backup file system 14. The former instance is trivial in that since the requested data is already stored at the correct offset in the local file, the migration module 24 is configured to simply instruct the intercepting module 26 to let the request fall through to the operating system module 22 for conventional file data routines and/or processing. However, if the module 24 determines that the requested data block needs to be retrieved from the backup file system 14, the module 24 is configured to access, via a communication link (e.g., via TCP/IP sockets, or similar communication techniques not shown), the backup file system 14 to request the corresponding backup data block or byte range matching the requested local backup block, which was previously backed to the corresponding backup file. The backup server 14 typically is configured to respond fairly quickly to the migration module 24 with the requested data block as the byte ranges usually requested are fairly small (e.g., 4095 to 65536 bytes) which may further be limited by the module 26.

The module 24 is further configured to store or write the data block received from the backup server in or to the corresponding local file, at the relevant offset, such that further local data requests for the same data block may be satisfied. In one example embodiment, the module 24 is configured to pass the retrieved data block to the intercepting module 26 which in turn supplies the same to the operating system module 22 which then forwards the same to the data requestor module 28. Instead, or in addition, the module 24 is configured to instruct the module 26 to allow the operating system module 22 call to fall to the normal handling as mentioned above.

The module 24 is configured to store or write data blocks to the pre-allocated local file in the existing local file system 12 without the need for having to re-write an entire volume containing the said local file. In this way, the module 24 can be configured to live restore to any volume, including the system volume.

The migration module 24 and/or the intercepting module 26 may be configured to maintain a log, for example in memory or a database to keep track of all data blocks written to a particular local file. The module 24 may be configured to pre-allocate data blocks within a local file and maintain a log of data written thereto in this regard. When data requestor module 28 writes data to the local file, the requests can just be passed to the operating system module 22 to write the data to local file in a conventional manner. The module 26 may be configured to keep track of the said write requests by the module 28. For example, to prevent a newly stored data block written by the module 28 being overwritten by older backed-up data stored in the backup file.

It will be appreciated that data requests that need to be fulfilled from the remote backup file system 14 may be slower than local storage, for example, due to communication lag associated with the network 16 or hardware shortfalls. However, as more and more data blocks get committed to local storage in the local files, the speed at which data requests are handled will increase until all data blocks can be supplied from local storage. Depending on the data access patterns of the requesting module 28, all the data blocks may become filled in by caching requests. Instead, idle time can be used wherein the migration module 24 is configured to request missing data blocks from the backup file system 14 and fills in the whole local file. This of course may be done for each file to be restored from the backup file system 14 such that the requestor module 28 can still operate without downtime or in other words a complete system shutdown whilst the backup data is migrated to the local file system 12.

Eventually the local file will be completely independent of remote backup data blocks (i.e. all local data blocks have been written to) stored in the backup file. At this point the migration module 24 is configured to control the intercepting module to stop monitoring requests to and from the file, or even unload itself completely. After this the requesting module 28 continues to have full use of the local file since it is just a standard file committed to local storage in the device 20. It is as if the complete file has been restored, with the difference from normal restores being that the requesting module 28 has had full use of the file the whole time.

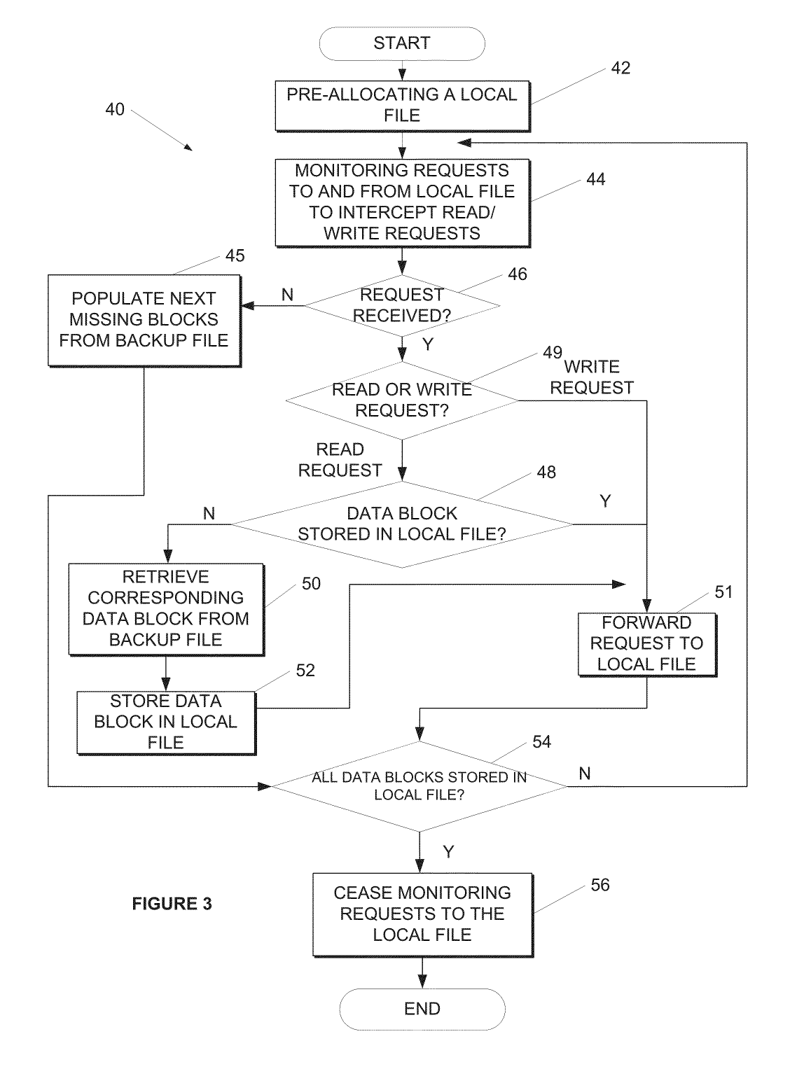

An example embodiment will now be further described, in use, with reference to FIG. 3. The example method shown in FIG. 3 is described with reference to FIGS. 1 and 2, although it is to be appreciated that the example methods may be applicable to other systems (not illustrated) as well.

In FIG. 3, a flow diagram of a method for migrating data from a backup file system 14 to a local file system 12 is generally indicated by reference numeral 40.

The method 40 usually commences when it is desired to migrate or restore data, particularly migrate or restore, from the remote backup file system 14 to the local file system 12, for example, in the event of a disaster scenario at the latter such as a natural disaster, a hardware malfunction, a malicious act, or the like. As previously mentioned, the files or data stored in the backup file system 14 was previously stored on the backup file system 14, for example, using conventional techniques for backing data.

In any event, for each local file to be restored with a backup file associated with the same, the method 40 comprises pre-allocating, at block 42, in the data storage device 20 of the local computing system 12, a local file substantially matching at least an identifier and size of a corresponding backup file stored in the backup file system 14 as mentioned above. It will be appreciated that the local file system 12 may receive a listing of all the files and sizes thereof to be restored and may pre-allocate a plurality of local files accordingly. The step of pre-allocating preferably comprises pre-allocating one or more local file/s within an existing volume or existing local file system 12. Thus there is no need for replacement of the whole existing volume in the case of a data migration and/or restore.

For ease of explanation, a single pre-allocated local file within the pre-existing file system 12 will be discussed further. It will be noted that the pre-allocation of files may comprise the step of pre-allocating block locations within the files.

Once the pre-allocation step is completed, the local file is available for use by the module 28 within the existing local file system 12. In particular, under control of the module 24, the method 40 comprises the step of monitoring, at block 44 by way of the intercepting module 26, requests to and from the pre-allocated local file made by the data requesting module 28. As mentioned, the module 26 may do this under control of the migration module 24 or autonomously by intercepting requests for data blocks to and from the local file made by the data requesting module 28 to the operating system module 22. As mentioned above, the module 26 may be in the form of a filter driver located or disposed between the operating layer and application layer of the first computing system 12.

If a request is not intercepted and/or received, at block 46 by way of module 26, the method 40 comprises the step of populating, at block 45, the next missing data blocks in the local file with data blocks from the backup file. This may be achieved by the module 24 retrieving and storing the data blocks in a similar fashion as described above. It will be understood that this automatic migration of data may be effectively interrupted on receipt of read or write requests, as the case may be.

If a request is intercepted and received, at block 46 via the module 26 which in turn transmits the same to the module 24, the method 40 comprises determining, at block 49, whether the request received is a read or write request. If the request is a read request for a data block stored in the local file, the method 40 comprises determining, at block 48 by way of the module 24, whether the data block requested is stored in the local file in the data storage device 20. In particular, the block information associated with the received request is interrogated (e.g., by way of module 24) to determine the identity or name of the pre-allocated file of interest and the location (offset and length) in the said file of the particular data block of interest. For example, a request may identify the local file X and local data block located at offset 4096 bytes with length of 65536 bytes within file X as the data block requested

If the particular data block of interest in the identified local file X is empty or not written to, the method 40 comprises retrieving, at block 50 by way of the migration module 24, a corresponding backup data block located at offset 4096 bytes with length 65536 bytes in backup file X stored in the backup file system 14. Though not illustrated, the method 40 may therefore comprise establishing a communication link with the backup file system 14 to this end.

It will be understood from the above example that the determined name of the local file and moreover the location of the requested data block therein is substantially the same as, if not identical to, the backup file. It follows that the module 24 uses the determined name and location to retrieve the corresponding backup data block from the backup file system 14, which of course corresponds to the data block which is requested.

In response to retrieving the backup data block, the method 40 comprises, storing or writing, at block 52 by way of module 24, the retrieved backup data block to local file X at the offset 4096 bytes with length 65536 bytes in local file X. In this way, the retrieved backup data block becomes part of the local file X which is accessible locally.

The method 40 then comprises forwarding, at block 51, the received request to the local file for conventional processing to service the request by the module 26.

Though not illustrated, in some example embodiments, the method 40 may comprise passing the retrieved backup data block to the intercepting module 26 which in turn supplies the same to the operating system module 22 which then forwards the same to the data requestor module 28. Instead, or in addition, the method 40 comprises instructing the module 26 to allow the operating system module 22 calls to fall to the normal handling as mentioned above. This may of course be followed should the determination at block 48 find the requested data block to be already stored locally.

It will be understood that the step in block 51 may be followed in response to determining receipt of a write request being received in the step in block 49.

In any event, the method 40 comprises determining, at block 54 via module 24 or module 26, if all data blocks are stored locally in a file or in other words whether all the data blocks in the local file are populated. In this step, regard may be had to the local file itself and/or the abovementioned log to determine the missing data blocks to populate in the local file.

If the file is populated, the method 40 comprises, at block 56, stopping monitoring requests thereto via the module 26. However, it follows that should there be more data blocks to be written to the local file the method comprises continuously polling or monitoring for requests for data blocks from the local file, as described above.

It will be noted that the step in block 45 may proceed to the step in block 54 such that the automatic migration of data in the absence of requests received may be stopped once the local file has been completely populated.

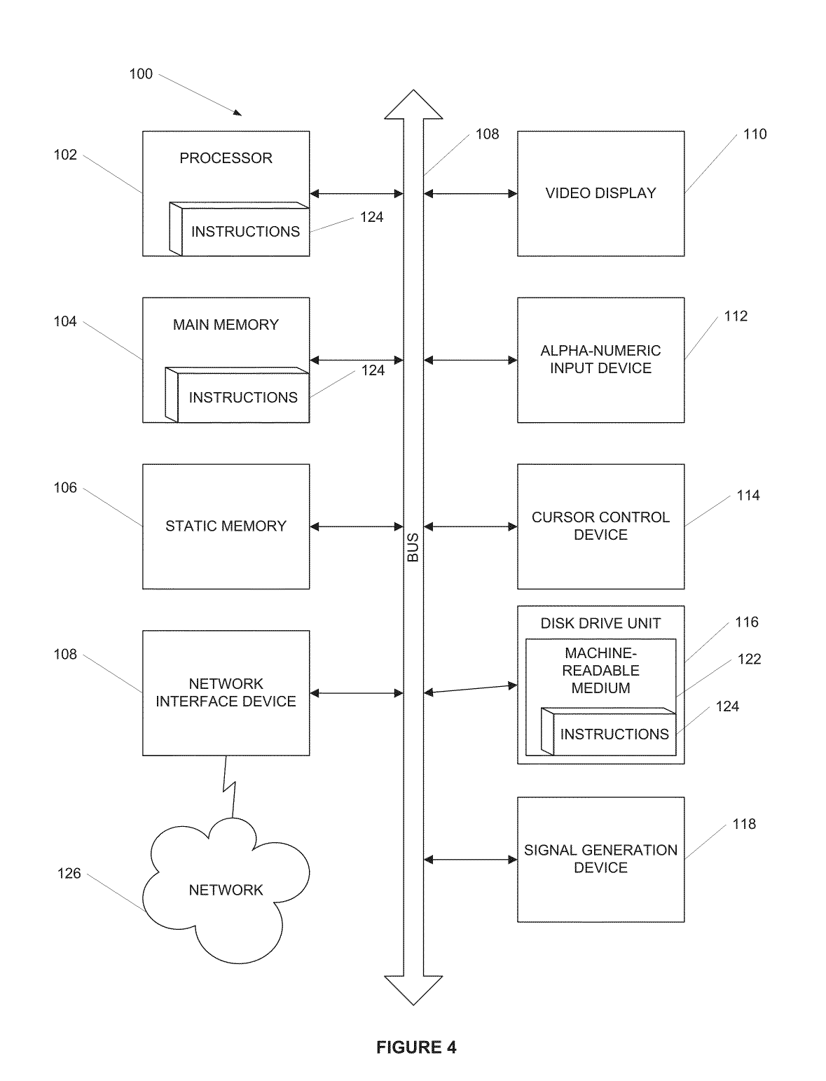

FIG. 4 shows a diagrammatic representation of machine in the example of a computer system 100 within which a set of instructions, for causing the machine to perform any one or more of the methodologies discussed herein, may be executed. In other example embodiments, the machine operates as a standalone device or may be connected (e.g., networked) to other machines. In a networked example embodiment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated for convenience, the term “machine” shall also be taken to include any collection of machines that individually or jointly execute a set (or multiple sets) of instructions to perform any one or more of the methodologies discussed herein.

In any event, the example computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse, or touchpad), a disk drive unit 116, a signal generation device 118 (e.g., a speaker) and a network interface device 120.

The disk drive unit 16 includes a machine-readable medium 122 storing one or more sets of instructions and data structures (e.g., software 124) embodying or utilised by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilising any one of a number of well-known transfer protocols (e.g., HTTP).

Although the machine-readable medium 122 is shown in an example embodiment to be a single medium, the term “machine-readable medium” may refer to a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilised by or associated with such a set of instructions. The term “machine-readable medium” may accordingly be taken to include, but not be limited to, solid-state memories, optical and magnetic media, and carrier wave signals.

The invention essentially provides a means of presenting or exposing files as if they were part of the local file system while still being located at a remote file system. This results in the files in the local file system immediately usable while it is being automatically migrated from remote backup storage to the local permanent storage. Furthermore files do not need to be manually migrated to permanent local storage. This reduces downtime during migration of data from one server or computing system to another.

In addition, it will be noted that the invention as described herein allows a user to migrate (restore) an individual file to an existing file system (while being able to access the target file during the migration process). Differently defined, the invention provides for the copying of a single file over the network to an existing drive with existing files. For example, a drive containing 10 SQL databases in 10 separate files. If one of the databases becomes corrupt, the present invention provides for live migration of only the affected SQL database without overwriting or touching the other 9 on the volume.

The new file simply gets added but with the benefit of immediate access during migration. The invention also provides a means to live restore to the System Volume which is not possible with volume based live restore systems.

1. A method of migrating data stored in a second computing system to a first computing system, wherein the method comprises:
pre-allocating, in a data storage device of the first computing system, at least one primary file substantially matching at least an identifier and size of a corresponding secondary file stored in a suitable data storage device of the second computing system;
intercepting a read request or a write request for a data block stored in the at least one primary file;
determining, in response to intercepting a read request, whether or not the requested data block is stored in the primary file;
in response to determining that the requested data block is not stored in the primary file, retrieving a data block corresponding substantially to the requested data block from the secondary file;
storing the retrieved requested data block from the secondary file accordingly in the at least one primary file such that the retrieved data block is presented in the first computing system; and
retrieving other data blocks from the secondary file and storing the retrieved other data blocks correspondingly in the at least one primary file, in the absence of receiving read or write requests, until the primary file is complete in respect of data blocks stored.

2. The method as claimed in claim 1, wherein the method comprises interrogating the intercepted read or write request to determine block information indicative of the data block associated with said request, wherein the block information comprises:
identifier information to identify the at least one primary file to which the request for the data block relates; and
location information to determine a location of the requested data block within the primary file, wherein the location information comprises a data offset and length of the requested data block.

3. The method as claimed in claim 1, wherein the at least one primary file is an individual file, and wherein the method comprises pre-allocating the individual at least one primary file to an existing file system stored in the data storage device of the first computing system.

4. The method as claimed in claim 1, wherein, in response to storing retrieved requested data block in the at least one primary file, the method comprises forwarding the received read request to the at least one primary file for processing or transmitting the retrieved requested data block to a data requestor of the requested data block.

5. The method as claimed in claim 1, wherein the method comprises maintaining a log of data block locations in the primary file which have data blocks stored therein.

6. The method as claimed in claim 5, wherein in response to receiving a write request to store a data block in a particular data block location, the method comprises storing the data block in the particular data block location in the at least one primary file.

7. The method as claimed in claim 5, wherein the method comprises:
monitoring and intercepting requests to and from the at least one primary file in an existing file system;
determining whether or not all data block locations in the at least one primary file have data blocks stored therein; and
ceasing monitoring and intercepting requests to and from the at least one primary file in response to determining that all data block locations in the at least one primary file have data blocks stored therein.

8. The method as claimed in claim 1, wherein the first computing system is a local file system comprising an existing file system stored in the data storage device of the first computing system; and the second computing system is a back-up file storage system communicatively coupled to the local file system.

9. A system for migrating data stored in a second computing system to a first computing system, the system comprising a migration module configured to:
pre-allocate, in a data storage device of the first computing system, at least one primary file substantially matching at least an identifier and size of a corresponding secondary file stored in a suitable data storage device of the second computing system;
receive a read request or a write request for a data block stored in the at least one primary file;
determine, in response to receiving a read request, whether or not the requested data block is stored in the primary file;
in response to determining that the requested data block is not stored in the primary file, retrieve a data block corresponding substantially to the requested data block from the secondary file;
store the retrieved requested data block from the secondary file accordingly in the at least one primary file such that the retrieved data block is presented in the first computing system; and
retrieve other data blocks from the secondary file and store the retrieved other data blocks correspondingly in the at least one primary file, in the absence of receiving read or write requests, until the primary file is complete in respect of data blocks stored.

10. The system as claimed in claim 9, wherein the system comprises an intercepting module communicatively coupled to the migration module and disposed between an operating system or operating system module and application layer of the first computing system, wherein the intercepting module is configured to monitor requests to and from the at least one primary file in the first computing system, and wherein the requests comprise block information indicative of data blocks associated with said requests.

11. The system as claimed in claim 10, wherein the block information comprises:
identifier information to identify the at least one primary file to which the request for the data block relates; and
location information to determine a location of the requested data block within the primary file, wherein the location information comprises a data offset and length of the requested data block.

12. The system as claimed in claim 10, wherein the intercepting module is in the form of one of a filter driver, mini-filter driver, and reparse point to intercept and/or receive requests directed to the operating system of the first computing system by one or more application/s

13. The system as claimed in claim 9, wherein the at least one primary file is an individual file in an existing file system stored in the storage device of the first computing system.

14. The system as claimed in claim 10, wherein the intercepting module and/or the migration module is configured to maintain or populate a log of those data block locations in the primary file which have corresponding retrieved data blocks stored therein.

15. The system as claimed in claim 10, wherein, in response to intercepting and/or receiving a write request, the migration module and/or the intercepting module is configured to store or write a data block associated with the write request in the at least one primary file.

16. The system as claimed in claim 10, wherein in response to retrieving, from the secondary file, and storing, in the primary file, the data block requested, the intercepting module is configured to transmit the data block requested to the requesting application, transmit the retrieved data block to the operating system for transmission to the application, and/or instruct the operating system to retrieve the data block requested from the primary file in which the same is stored.

17. The system as claimed in claim 10, wherein the migration module and/or the intercepting module is configured to retrieve the requested data block from the at least one primary file in response to determining that the requested data block is stored in the at least one primary file.

18. The system as claimed in claim 10, wherein the intercepting module is configured to determine whether all data block locations in a primary file have retrieved data stored therein or not, the intercepting module being configured to cease monitoring requests to and from the primary file in response to determining that all data block locations in the primary file have been retrieved data blocks stored therein.

19. The system as claimed in claim 9, wherein the first computing system is a local file system and the second computing system is a back-up file storage system communicatively coupled to the local file system.

20. A non-transitory computer readable storage medium comprising a set of instructions, which when executed by a computing device causes the same to:
pre-allocate, in a data storage device of the first computing system, at least one primary file substantially matching at least an identifier and size of a corresponding secondary file stored in a suitable data storage device of the second computing system;
receive a read request or a write request for a data block stored in the at least one primary file;
determine, in response to receiving a read request, whether or not the requested data block is stored in the primary file;
in response to determining that the requested data block is not stored in the primary file, retrieve a data block corresponding substantially to the requested data block from the secondary file;
store the retrieved requested data block from the secondary file accordingly in the at least one primary file such that the retrieved data block is presented in the first computing system; and
retrieve other data blocks from the secondary file and store the retrieved other data blocks correspondingly in the at least one primary file, in the absence of receiving read or write requests, until the primary file is complete in respect of data blocks stored.
